(19) United States
(12) Patent Application Publication
(10) Pub. No.: US 2003/0061757 A1
(43) Pub. Date: Apr. 3, 2003

(54) Apparatus for attracting and killing insects

(76) Inventor: Clinton G. Askin, Duncan (CA)

Correspondence Address: Gerald O.S. Oyen, Oyen Wiggs Green & Mutala, #480 - 601 West Cordova St., Vancouver, BC, V6B 1G1, CA

(21) Appl. No.: 09/968,909

(22) Filed: Oct. 3, 2001

(51) Int. Cl. A01M 1/22

(52) U.S. Cl. 43/112

(57) ABSTRACT

An apparatus for attracting and killing insects, the apparatus comprising: a fuel storage tank containing a fuel; a flame generating member in communication with the fuel; a first thermally conductive surface proximate to the flame generating member; a heat sink; at least one thermoelectric generator with a hot side thermally coupled to the first thermally conductive surface and a cool side thermally coupled to the heat sink, the thermoelectric generator producing a voltage and a current proportional to a temperature difference between the hot side and the cool side; an electronic circuit electrically coupled to the thermoelectric generator, the electronic circuit configured to convert the voltage and the current into an increased voltage differential; and, a conductive grid electrically coupled to the electronic circuit, wherein the fuel is combusted on the flame generating member, thereby producing carbon dioxide, water vapor and heat, and the heat increases a temperature of the first thermally conductive surface to create a temperature gradient between the hot side and the cool side of the thermoelectric generator, thereby producing the voltage and the current from the thermoelectric generator, and the electronic circuit provides the increased voltage differential to the conductive grid.

### TECHNICAL FIELD

This invention relates to insect attraction and killing, and particularly to a novel apparatus which attracts biting insects by generating heat, carbon dioxide and water vapor and kills the insects by means of electrocution. This invention also relates to apparatus which are self contained and portable, with no requirement for pressurized fuel.

### BACKGROUND

People and other animals tend to emit heat, carbon dioxide and water vapor, and as such, are characterized by warm moist surface areas. Biting insects are attracted to heat, carbon dioxide and water vapor, and warm moist surfaces. Apparatus for attracting and killing insects which use heat, carbon dioxide and water vapor are known in the prior art. For example, U.S. Pat. No. 4,519,776 discloses an apparatus in which a pressurized gas such as propane is burned to produce heat, carbon dioxide, and water vapor, for the purpose of attracting insects to an electrified grid.

U.S. Pat. No. 4,785,573 discloses a lantern that includes a battery-powered electrified grid for killing insects, and a sound-emitting unit and odor-dispensing system for attracting insects to the grid.

U.S. Pat. No. 5,669,176 discloses an insect trap that uses a methanol fuel cell to produce heat, carbon dioxide and water vapor to attract insects. The fuel cell also produces electricity to power a fan which is used to trap insects in a mesh bag.

U.S. Pat. No. 5,799,436 discloses an apparatus for attracting and destroying insects in which pressurized carbon dioxide and octenol are used, along with a heat source such as an incandescent or infrared bulb to attract insects to an electrified grid powered by a high voltage transformer.

U.S. Pat. No. 6,050,025 discloses an infrared insect/mosquito killing system that uses an electric heater and a wide variety of aromatics to attract insects to an electrified grid.

U.S. Pat. No. 6,055,766 discloses an apparatus for attracting and destroying insects that uses a carbon dioxide source, an octenol source and a heating element to attract insects to an electrified grid powered by a pulsed, high-voltage coil.

U.S. Pat. No. 6,145,243 discloses a method and device for trapping insects that uses liquid propane fuel to generate heat, carbon dioxide, and water vapor to attract insects into a trap. A thermoelectric generator is used to provide electrical power to the device.

There exists a need for an inexpensive, portable, lightweight, self contained insect killing apparatus that does not require a separate electrical power source. There also exists a need for an insect killing apparatus that produces a warm moist surface area while generating carbon dioxide using a clean burning, liquid fuel that does not need to be pressurized.

### SUMMARY OF INVENTION

The invention provides an apparatus for attracting and killing insects comprising: a fuel storage tank containing a fuel; a flame generating member in communication with the fuel; a first thermally conductive surface proximate to the flame generating member; a heat sink; at least one thermoelectric generator with a hot side thermally coupled to the first thermally conductive surface and a cool side thermally coupled to the heat sink, the thermoelectric generator producing a voltage and a current proportional to a temperature difference between the hot side and the cool side; an electronic circuit electrically coupled to the thermoelectric generator, the electronic circuit configured to convert the voltage and the current into an increased voltage differential; and, a conductive grid electrically coupled to the electronic circuit, wherein the fuel is combusted on the flame generating member, thereby producing carbon dioxide, water vapor and heat, and the heat increases a temperature of the first thermally conductive surface to create a temperature gradient between the hot side and the cool side of the thermoelectric generator, thereby producing the voltage and the current from the thermoelectric generator, and the electronic circuit provides the increased voltage differential to the conductive grid.

The fuel may be a hydrocarbon fuel, and may further be an unpressurized liquid. The fuel may be methyl hydrate.

The flame generating member may be a fuel wick in fluid communication with the fuel.

The first thermally conductive surface may be positioned above the flame generating member.

The heat sink may be a second thermally conductive surface.

The apparatus may further comprise a water reservoir and at least one water wick.

The water wick may be in fluid communication with the water reservoir, and the water wick may be thermally coupled to the second thermally conductive surface.

The water wick may be held against the second thermally conductive surface by a perforated sheet.

The grid may comprise an outer grid and an inner grid, the outer grid electrically insulated from the inner grid, and the circuit may apply the increased voltage differential between the outer grid and the inner grid.

The water wick may comprise a warm, moist surface area.

The invention further provides an apparatus for attracting and killing insects comprising: a fuel storage tank containing an unpressurized liquid hydrocarbon fuel; a fuel wick in fluid communication with the fuel; a first thermally conductive surface positioned above the fuel wick; a water reservoir containing water; a water wick in fluid communication with the water; a second thermally conductive surface positioned remote from the fuel wick, the second thermally conductive surface thermally coupled to the water wick; at least one thermoelectric generator with a hot side thermally coupled to the first thermally conductive surface and a cool side thermally coupled to the second thermally conductive surface, the thermoelectric generator producing a voltage and a current proportional to a temperature difference between the hot side and the cool side; an electronic circuit electrically coupled to the thermoelectric generator, the electronic circuit configured to convert the voltage and the current into an increased voltage differential; and, a conductive grid electrically coupled to the electronic circuit, wherein the fuel is combusted on the fuel wick, thereby producing carbon dioxide, water vapor and heat, and the heat increases a temperature of the first thermally conductive surface, and the water is drawn up the water wick and evaporates, thereby decreasing a temperature of the second thermally conductive surface to create a temperature gradient between the hot side and the cool side of the thermoelectric generator, thereby producing the voltage and the current from the thermoelectric generator, and the electronic circuit provides the increased voltage differential to the conductive grid.

### BRIEF DESCRIPTION OF DRAWINGS

FIG. 1 is an isometric view of an apparatus constructed according to a preferred embodiment of the invention.

FIG. 2 is an exploded view of an attractor constructed according to a preferred embodiment of the invention.

FIG. 3 is a sectional view of the base of the apparatus shown in FIG. 1.

FIG. 4 is an isometric view of the housings and grid of the apparatus shown in FIG. 1.

FIG. 5 is a side elevation view of the apparatus of FIG. 1 with the housings and attractor removed from the base.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Construction

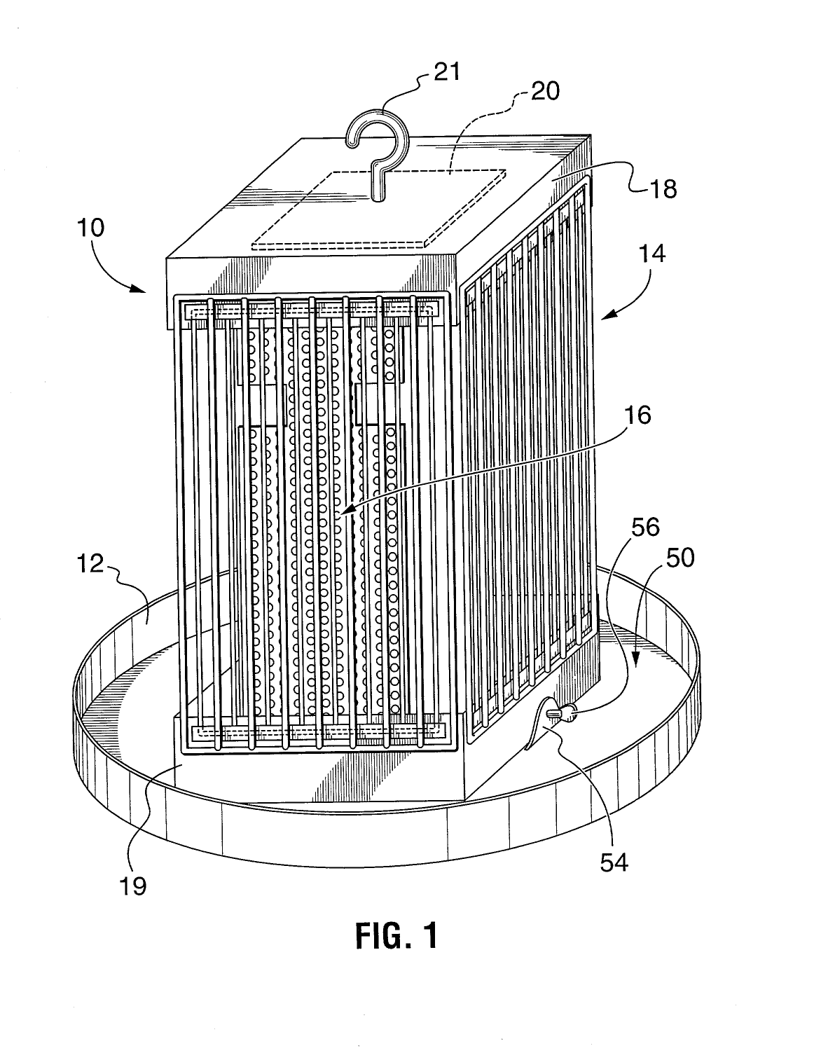

FIG. 1 shows a preferred embodiment of an apparatus 10 constructed according to the invention. Apparatus 10 comprises a base 12, a conductive grid 14, an insect attractor 16, a top housing 18 and a bottom housing 19. Top housing 18 is attached to the top of grid 14, and bottom housing 19 is attached to the bottom of grid 14. Attractor 16 as attached to bottom housing 19. The apparatus 10 may further comprise a protective insulating grid (not shown) to prevent accidental contact with the conductive grid 14. Top housing 18 contains an electronic circuit 20 which receives electrical power from a pair of thermoelectric generators 36 (see below) in attractor 16. Circuit 20 uses the electrical power to electrify grid 14 so that any insects which come into contact with grid 14 will be either electrocuted or at least disabled. A hook 21 may be attached to top housing 18 to facilitate hanging of apparatus 10.

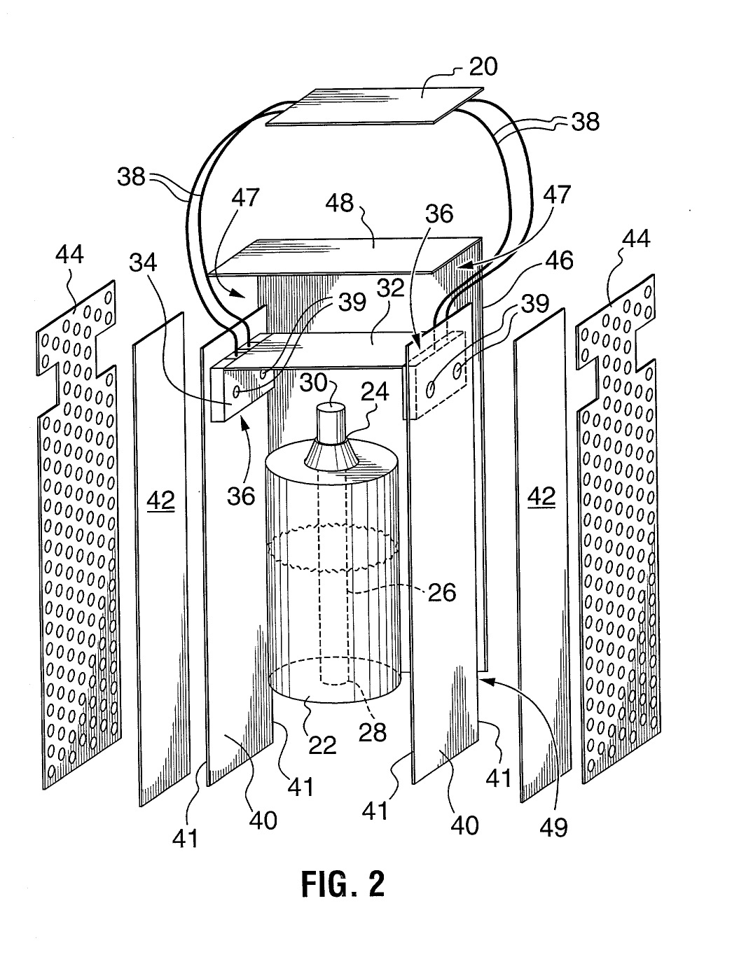

The construction of attractor 16 is shown in FIG. 2. Actuator 16 is configured to fit over a fuel storage tank 22 which contains a preferably unpressurized liquid hydrocarbon fuel. The fuel will produce heat, carbon dioxide and water vapor when burned, and is preferably methyl hydrate. The inventor has determined that methyl hydrate produces combustion products which are well suited for attracting insects, particularly mosquitos, and more particularly female mosquitos, which bite humans and animals.

Tank 22 has an opening 24 defined in a top end thereof. A fuel wick 26 is inserted into tank 22 through opening 24. Wick 26 has a lower end 28 immersed in the fuel, and an upper end 30 which extends a suitable distance out opening 24 so that combustion of fuel can safely occur at upper end 30 of wick 26. The bottom of tank 22 is mounted on base 12, as described below.

Attractor 16 comprises a first thermally conductive surface 32 positioned a suitable distance above upper end 30 of wick 26. The suitable distance may be, for example, approximately one inch, however the distance may vary according to the overall size of attractor 16, and of the characteristics of the fuel and wick 26. Conductive surface 32 preferably has a rectangular shape and comprises two flanges 34 which extend downwardly from opposite sides of surface 32. Surface 32 and flanges 34 are preferably constructed from a single sheet of aluminum.

A thermoelectric generator 36 is preferably coupled to the outside of each flange 34. Thermoelectric generators 36 each have a hot side which is coupled to flange 34, and a cold side opposite the hot side. Thermoelectric generators 36 employ the Seebeck effect to produce voltage and current proportional to the temperature difference between the hot side and the cold side. Thermoelectric generators 36 are each preferably comprised of bismuth-telluride cubes, although other materials would also be suitable. Wires 38 are used to electrically connect generators 36 to electronic circuit 20.

Coupled to the outsides of generators 36 are second thermally conductive surfaces 40. Conductive surfaces 40 are preferably rectangular aluminum sheets. Conductive surfaces 40 are held in place by insulating fasteners 39, which are attached to flanges 34. Insulating fasteners 39 hold surfaces 40 tight against generators 36, thereby securing generators 36 between flanges 34 and surfaces 40.

A cooling wick 42 is held against the outside of each conductive surface 40 by a perforated sheet 44. The bottoms of wicks 42 extend below the bottoms of surfaces 40, and are immersed in water reservoir 50, as described below. As surfaces 40 are heated by combustion of the fuel, water in wicks 42 evaporates, thereby cooling surfaces 40 and presenting a moist, warm surface area which serves to attract biting insects. Wicks 42 are preferably constructed of fiberglass. Perforated sheets 44 are preferably constructed of aluminum.

Attached to edges 41 of surfaces 40 are side covers 46 (only one side cover 46 is shown in FIG. 2 to avoid obscuring the other features of attractor 16). Side covers 46 are preferably held in place by small screws inserted into threaded holes in edges 41 (not shown), or other suitable fasteners. The outside of surfaces 40 and side covers 46 are preferably colored black, because biting insects are attracted to dark colors.

Side covers 46 preferably comprise inwardly extending flanges 48. Flanges 48 serve to deflect heat away from top housing 19. Side covers 46 and flanges 48 are preferably thermally conductive, so that as flanges 48 are heated, the heat is transferred to side covers 46 and the hot gasses produced from combustion of the fuel are cooled. Side covers 46 extend above surfaces 40 so that exhaust ventilation gaps 47 are formed between flanges 48 and surfaces 40 to allow heated carbon dioxide and water vapor to escape attractor 16. Side covers 46 do not extend all the way to the bottoms of surfaces 40 so that intake ventilation gaps 49 are formed below side covers 46 to allow combustion air into attractor 16 to reach the upper end 30 of wick 26. The bottom portions of side covers 46 are attached to bottom housing 18 by suitable fasteners, such as screws (not shown).

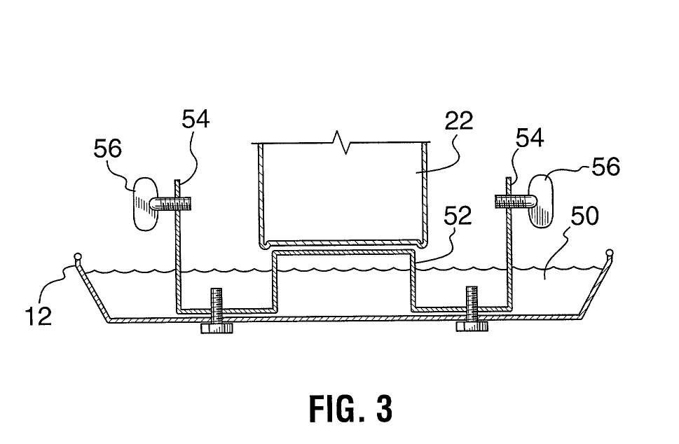

As best shown in FIG. 3, base 12 preferably comprises water reservoir 50 which supplies water to cooling wicks 42. Base 12 further comprises raised portion 52 configured to accommodate and support tank 22, and upwardly extending flanges 54 equipped with wing nuts 56, or other suitable fasteners, to effect attachment of base 12 to bottom housing 19.

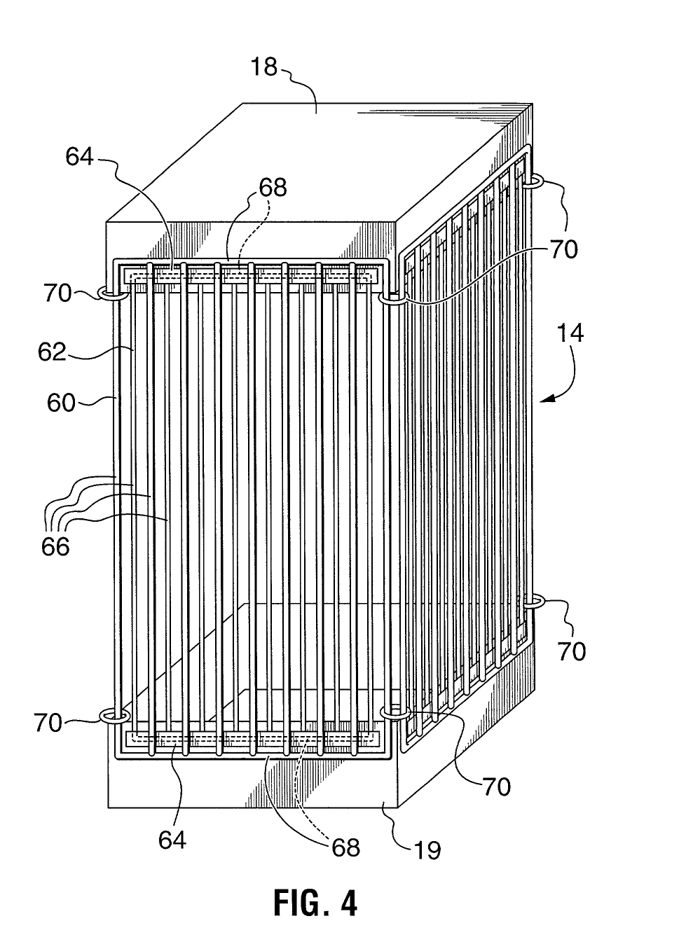

Grid 14 comprises an outer grid 60 and an inner grid 62 attached to each of the four sides of housings 18, 19 in the embodiment shown in FIG. 1. Outer and inner grids 60, 62 are connected to electronic circuit 20 so that grids 60, 62 are oppositely charged. Outer and inner grids 60, 62 are electrically isolated from each other by insulating strips 64 as shown in FIG. 4. Insulating strips 64 may comprise PVC tape or any suitable electrical insulators.

Outer grids 60 and inner grids 62 each comprise a plurality of vertical bars 66 and two cross bars 68. One cross bar 68 is provided at both the top and bottom of each outer grid 60 and inner grid 62. Outer grids 60 are all electrically connected to each other by means of rings 70 or other such conductive pathways. Rings 70 serve to hold outer grids 60 against inner grids 62, with insulating strips 64 therebetween to prevent current from flowing between outer and inner grids 60 and 62. Likewise, inner grids 62 are electrically connected to each other by wires (not shown).

It will be appreciated that housings 18, 19 need not be square, and therefore grid 14 may have a shape other than that shown in the Figures. For example, if housings 18, 19 are circular, outer and inner grids 62 will form two coaxial cylinders.

Operation

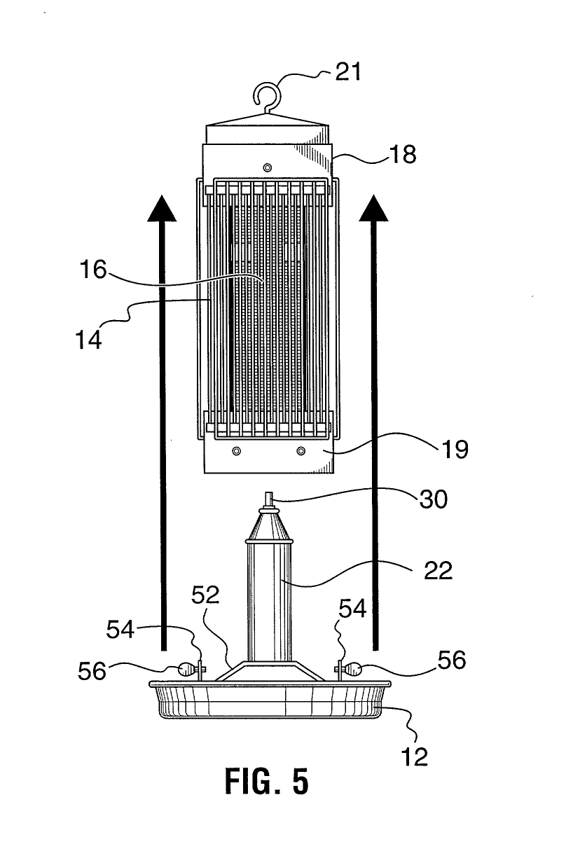

In operation, a user will loosen wing nuts 56 and remove grid 14, actuator 16 and housings 18, 19 from base 12, as shown in FIG. 5. After ensuring that tank 22 contains sufficient fuel and is secured on raised portion 52 of base 12, the user will light the upper end 30 of wick 26 by suitable means, such as a match or lighter. The user will then replace the grid 14, actuator 16 and housings 18, 19 over tank 22 and secure base 12 to bottom housing 12 by tightening wing nuts 56.

As fuel is burned at the upper end 30 of wick 26, surface 32 gets hot. This creates a temperature gradient across generators 36, which convert that thermal energy into electrical energy which is passed along wires 38 to power circuit 20. In addition to the heat, carbon dioxide and water vapor are also produced, which attract biting insects.

The outsides of generators 36 are kept cool by surfaces 40, which act as heat sinks. As heat is transferred to surfaces 40, water in wicks 42 evaporates, thereby cooling surfaces 40. This evaporation also releases a large amount of warm water vapor from a large moist surface area, which helps attract biting insects by simulating a human or animal. As the water in wicks 42 evaporates, more water is drawn up from reservoir 50. The user will have to refill the water in reservoir 50 from time to time to ensure that the bottoms of wicks 42 remain submerged.

Electronic circuit 20 receives electrical power from generators 36, and provides a voltage of between 250 and 1500 volts, preferably between 600 and 1000 volts across outer grid 60 and inner grid 62. Electronic circuit 20 comprises standard components for stepping up a direct current voltage, such as a switching transistor, transformer and a rectifier. As one skilled in the art will appreciate, an extremely large number of possible variations of electronic circuit 20 would be suitable to accomplish the desired function of providing a voltage of between 600 and 1000 volts across outer grid 60 and inner grid 62. This voltage is sufficient to kill most biting insects. Insects that are merely stunned will fall into water reservoir 50 and drown.

As will be apparent to those skilled in the art in the light of the foregoing disclosure, many alterations and modifications are possible in the practice of this invention without departing from the spirit or scope thereof. For example:

the fuel could be smokeless liquid parafin, butane, lighter fluid or other clean burning hydrocarbon instead of methanol;

the fuel tank could be replaced with a clean burning candle;

perfumes or pheromones could be added to the fuel;

the base could be an integral part of the bottom housing;

the housings could be shaped differently.

Accordingly, the scope of the invention is to be construed in accordance with the substance defined by the following claims.

What is claimed is:

1. An apparatus for attracting and killing insects, the apparatus comprising:
(a) a fuel storage tank containing a fuel;
(b) a flame generating member in communication with said fuel;
(c) a first thermally conductive surface proximate to said flame generating member;
(d) a heat sink;
(e) at least one thermoelectric generator with a hot side thermally coupled to said first thermally conductive surface and a cool side thermally coupled to said heat sink, said thermoelectric generator producing a voltage and a current proportional to a temperature difference between said hot side and said cool side;
(f) an electronic circuit electrically coupled to said thermoelectric generator, said electronic circuit configured to convert said voltage and said current into an increased voltage differential; and,
(g) a conductive grid electrically coupled to said electronic circuit,
wherein said fuel is combusted on said flame generating member, thereby producing carbon dioxide, water vapor and heat, and said heat increases a temperature of said first thermally conductive surface to create a temperature gradient between said hot side and said cool side of said thermoelectric generator, thereby producing said voltage and said current from said thermoelectric generator, and said electronic circuit provides said increased voltage differential to said conductive grid.

2. The apparatus of claim 1 wherein said fuel is a hydrocarbon fuel.

3. The apparatus of claim 2 wherein said fuel is an unpressurized liquid.

4. The apparatus of claim 3 wherein said fuel is methyl hydrate.

5. The apparatus of claim 1 wherein said flame generating member is a fuel wick in fluid communication with said fuel.

6. The apparatus of claim 1 wherein said first thermally conductive surface is positioned above said flame generating member.

7. The apparatus of claim 1 wherein said heat sink is a second thermally conductive surface.

8. The apparatus of claim 7 wherein said apparatus further comprises a water reservoir and at least one water wick.

9. The apparatus of claim 8 wherein said water wick is in fluid communication with said water reservoir, and wherein said water wick is thermally coupled to said second thermally conductive surface.

10. The apparatus of claim 9 wherein said water wick is held against said second thermally conductive surface by a perforated sheet.

11. The apparatus of claim 1 wherein said grid comprises an outer grid and an inner grid, said outer grid electrically insulated from said inner grid, and wherein said circuit applies said increased voltage differential between said outer grid and said inner grid.

12. The apparatus of claim 5 wherein said fuel is an unpressurized liquid hydrocarbon.

13. The apparatus of claim 12 wherein said fuel is methyl hydrate.

14. The apparatus of claim 5 wherein said first thermally conductive surface is positioned above said fuel wick.

15. The apparatus of claim 14 wherein said heat sink is a second thermally conductive surface.

16. The apparatus of claim 15 wherein said apparatus further comprises a water reservoir and at least one water wick.

17. The apparatus of claim 16 wherein said water wick is in fluid communication with said water reservoir, and wherein said water wick is thermally coupled to second thermally conductive surface.

18. The apparatus of claim 17 wherein said water wick is held against said second thermally conductive surface by a perforated sheet, and said water wick comprises a warm, moist surface area.

19. The apparatus of claim 9 wherein said water wick comprises a warm, moist surface area.

20. An apparatus for attracting and killing insects, the apparatus comprising:
(a) a fuel storage tank containing an unpressurized liquid hydrocarbon fuel;
(b) a fuel wick in fluid communication with said fuel;
(c) a first thermally conductive surface positioned above said fuel wick;
(d) a water reservoir containing water;
(e) a water wick in fluid communication with said water;
(f) a second thermally conductive surface positioned remote from said fuel wick, said second thermally conductive surface thermally coupled to said water wick;
(g) at least one thermoelectric generator with a hot side thermally coupled to said first thermally conductive surface and a cool side thermally coupled to said second thermally conductive surface, said thermoelectric generator producing a voltage and a current proportional to a temperature difference between said hot side and said cool side;
(h) an electronic circuit electrically coupled to said thermoelectric generator, said electronic circuit configured to convert said voltage and said current into an increased voltage differential; and,
(i) a conductive grid electrically coupled to said electronic circuit,
wherein said fuel is combusted on said fuel wick, thereby producing carbon dioxide, water vapor and heat, and said heat increases a temperature of said first thermally conductive surface, and said water is drawn up said water wick and evaporates, thereby decreasing a temperature of said second thermally conductive surface to create a temperature gradient between said hot side and said cool side of said thermoelectric generator, thereby producing said voltage and said current from said thermoelectric generator, and said electronic circuit provides said increased voltage differential to said conductive grid.
